(19) United States
(12) Patent Application Publication
(10) Pub. No.: US 2019/0205821 A1
(43) Pub. Date: Jul. 4, 2019

(54) AUTOMATED IDENTIFICATION, STATUS MONITORING AND NOTIFICATION OF STORED ITEMS

(71) Applicant: International Business Machines Corporation, Armonk, NY (US)

(72) Inventors: John S. Werner, Fishkill, NY (US); Kavita Sehgal, Poughkeepsie, NY (US); Diane M. Stamboni, Poughkeepsie, NY (US); Sneha M. Varghese, Fishkill, NY (US); Sarah Wu, Kingston, NY (US); Nicholas G. Danyluk, Long Island City, NY (US)

(21) Appl. No.: 15/861,085

(22) Filed: Jan. 3, 2018

(51) Int. Cl. G06Q 10/08; G01G 19/42; G01G 19/414; G06K 9/62; G06K 17/00

(52) U.S. Cl. CPC G06Q 10/087; G01G 19/42; G06K 2017/0051; G06K 9/6267; G06K 17/0022; G01G 19/4144

(57) ABSTRACT

Embodiments of the invention are directed to a computer-implemented method of monitoring items in a storage area. The method includes generating, using a sensor system, sensed weight data that represents weights of a plurality of stored items. The method further includes generating, using the sensor system, sensed surface area data that represents surface areas of the plurality of stored items. Based at least in part on the sensed weight data and the sensed surface area data, a classifier is used to create, train, and update a stored item model. Based at least in part on new sensed weight data and new sensed surface area data, the classifier and the stored item model are used to generate a stored item classification output.

### BACKGROUND

The present invention relates in general to computer-based control systems. More specifically, the present invention relates to methods, systems and computer program products for performing automated identification, status monitoring, and notifications of stored items.

The adjectives “smart” and/or “connected” are often used to describe the use of computer-based, networked technologies to augment the features of a product or a system. Smart/connected products are embedded with processors, sensors, software, and connectivity that allow data about the product to be gathered, processed, and transmitted to external systems. The data collected from smart/connected products can be analyzed and used to inform decision-making and enable operational efficiencies of the product.

Smart/connected technologies can be applied to a variety of storage areas, including, for example, refrigerators, closets, pantries, drawers, suitcases, and the like. An example is the so-called smart refrigerator having computing power, sensors, and network connectivity configured to manage stored items. Conventional smart refrigerators require either manual registration of stored items and/or that each stored item is provided with a barcode or radio frequency identification (RIFD) tag. Users can review the status of refrigerated items by checking an inventory list displayed on a display or other output device.

### SUMMARY

Embodiments of the invention are directed to a computer-implemented method of monitoring items in a storage area. The method includes generating, using a sensor system, sensed weight data that represents weights of a plurality of stored items. The method further includes generating, using the sensor system, sensed surface area data that represents surface areas of the plurality of stored items. Based at least in part on the sensed weight data and the sensed surface area data, a classifier is used to create, train, and update a stored item model. Based at least in part on new sensed weight data and new sensed surface area data, the classifier and the store item model are used to generate a stored item classification output.

Additional embodiments of the invention are directed to a computer system and a computer program product having features that correspond to the computer-implemented method described above.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts a block diagram of a system embodying aspects of the invention;

FIG. 2 depicts a block diagram of a portion of a system embodying aspects of the invention;

FIG. 3 depicts a block diagram showing additional details of a cloud computing portion of a system embodying aspects of the invention;

FIG. 4A depicts a block diagram illustrating a smart shelf system embodying aspects of the invention;

FIG. 4B depicts a block diagram illustrating a more detailed example of a smart shelf system embodying aspects of the invention;

FIG. 5 depicts a table illustrating examples of raw and calculated data from a smart shelf according to embodiments of the invention;

FIG. 6 depicts a flow diagram illustrating a methodology according to embodiments of the invention;

FIG. 7 depicts a cloud computing environment according to embodiments of the invention;

FIG. 8 depicts abstraction model layers according to an embodiment of the invention; and

FIG. 9 depicts details of an exemplary computing system capable of implementing aspects of the invention.

In the accompanying figures and following detailed description of the disclosed embodiments, the various elements illustrated in the figures are provided with two, three, or four digit reference numbers. In most instances, the leftmost digit(s) of each reference number corresponds to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The terms “storage area” and variations thereof can refer to a variety of confined/unconfined storage systems such as refrigerators, closets, pantries, drawers, bookcases, suitcases, and the like.

The term “bus” and variations thereof, as used herein, can refer to a subsystem that transfers information and/or data between various components.

The phrases “communication device,” “smartphone,” “mobile device,” and variations thereof, can be used interchangeably herein and can include any type of device capable of communicating with one or more of another device and/or across a communications network, via a communications protocol, and the like. Exemplary communication devices include but are not limited to smartphones, handheld computers, laptops, netbooks, notebook computers, subnotebooks, tablet computers, scanners, portable gaming devices, phones, pagers, and other network-connected devices.

The phrases “communications system,” “communications network,” and variations thereof, as used herein, can refer to a collection of communication components capable of one or more of transmission, relay, interconnect, control, or otherwise manipulate information or data from at least one transmitter to at least one receiver. As such, the communication can include a range of systems supporting point-to-point or broadcasting of the information or data. A communications system can refer to the collection individual communication hardware as well as the interconnects associated with and connecting the individual communication hardware. Communication hardware can refer to dedicated communication hardware or can refer a processor coupled with a communication means (i.e., an antenna) and running software capable of using the communication means to send and/or receive a signal within the communication system. Interconnect refers to some type of wired or wireless communication link that connects various components, such as communication hardware, within a communication system.

The phrases “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

Turning now to an overview of technologies that are more specifically relevant to aspects of the present invention, as previously noted herein, the adjectives “smart” and/or “connected” are often used to describe the use of computer-based, networked technologies to augment the features of a product or system. Smart/connected products are embedded with processors, sensors, software, and connectivity that allow data about the product to be gathered, processed, and transmitted to external systems. The data collected from smart/connected products can be analyzed and used to inform decision-making and enable operational efficiencies of the product.

Smart/connected technologies can be applied to a variety of storage areas, including, for example, refrigerators, closets, pantries, drawers, suitcases, and the like. An example is the so-called smart refrigerator having computing power, sensors, and network connectivity configured to recognize and manage stored items. Conventional smart refrigerators require either manual registration of stored items and/or that each stored item is provided with a barcode or a RIFD tag. Users can review the status of refrigerated items by checking an inventory list displayed on a display or other output device.

Turning now to an overview of aspects of the present invention, embodiments of the invention provide methods, systems, and computer program products for performing automated identification, status monitoring, and notifications of stored items. Embodiments of the invention use a camera and smart shelves to gather sensed data, along with a machine learning cognitive analyzer/classifier configured to use the sensed data to create/train/update a model of items stored on the smart shelves. The camera is configured to provide image data of the stored item. The smart shelves are configured to provide sensed data that includes both weight data and size data about the stored item. By generating and using training data that includes size, weight, and image data, the cognitive analyzer/classifier can perform (and/or learn) a wide range of cognitive determinations about stored items without having to rely on the user inputting the determinations directly. The learned cognitive determinations about stored items include but are not limited to an identification, size, weight, volume, expiration date, and the like.

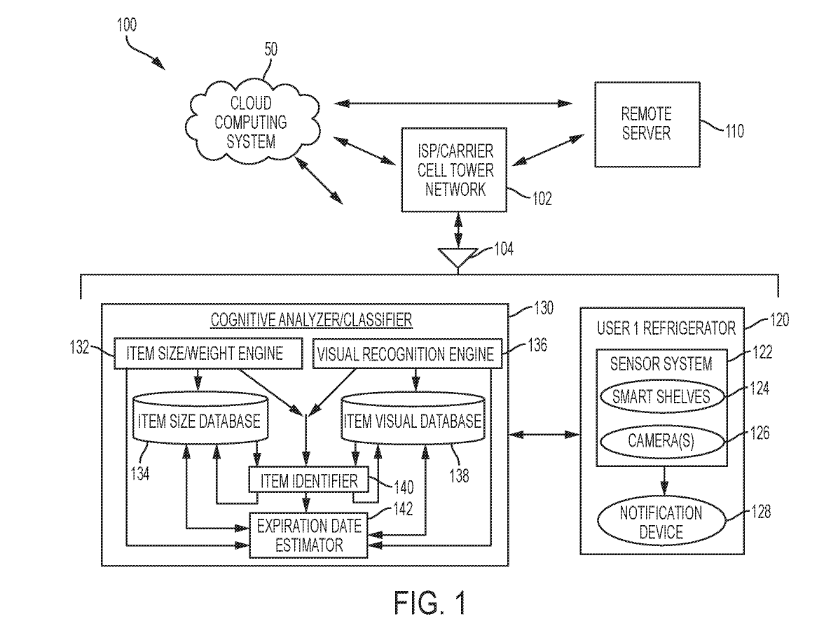

Turning now to a more detailed description of aspects of the invention, FIG. 1 depicts a diagram illustrating a system 100 according to embodiments of the invention. System 100 includes a smart refrigerator 120, an ISP/carrier cell tower network 102, a remote sever 110, and a cloud computing system 50, configured and arranged as shown. The smart refrigerator 120 includes an antenna system 104 and a cognitive analyzer/classifier 130, configured and arranged as shown. In embodiments of the invention, the cognitive analyzer/classifier 130 includes an item size/weight engine 132, an item size database 134, a visual recognitions engine 136, an item visual database 138, an item identifier 140, and an expiration data estimator 142, configured and arranged as shown. The smart refrigerator 120 includes a sensor system 122 and a notification device 128, configured and arranged as shown. The sensor system 122 includes smart shelves 124 and cameras 126, configured and arranged as shown.

In embodiments of the invention, the cognitive analyzer/classifier 130 can be integrated within the smart refrigerator 120 or can be provided as a separate device (e.g., in a mobile device, cloud computing system 50, remote server 110, etc.) communicatively coupled to the smart refrigerator 120. In accordance with embodiments of the invention, the cognitive analyzer/classifier 130 includes sufficient processing power to receive training data in the form of sensor readings from the sensor system 122 and apply machine learning techniques to generate stored item models and stored item classification outputs for the stored items in the smart refrigerator 120. Additional details of how the cognitive analyzer/classifier 130 operates according to embodiments of the invention are provided subsequently herein.

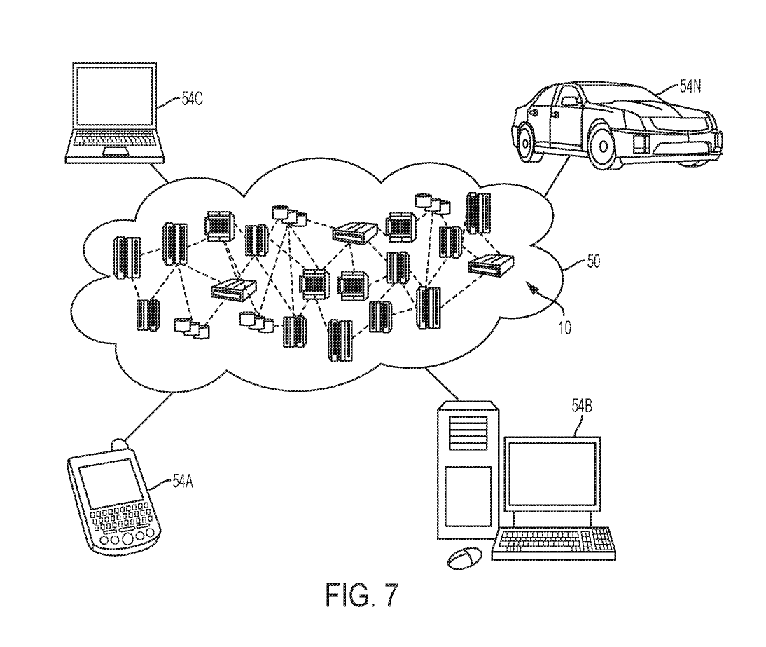

Cloud computing system 50 is in wired or wireless electronic communication with one or all of remote server 110, cell tower network 102, antenna system 104, and cognitive analyzer/classifier 130. Cloud computing system 50 can supplement, support, or replace some or all of the functionality of remote server 110, cell tower network 102, antenna system 104, and cognitive analyzer/classifier 130. Additionally, some or all of the functionality of remote server 110, cell tower network 102, antenna system 104, and cognitive analyzer/classifier 130 can be implemented as a node 10 (shown in FIG. 7) of cloud computing system 50.

Similarly, remote server 110 is in wired or wireless electronic communication with one or all of cloud computing system 50, cell tower network 102, antenna system 104, and cognitive analyzer/classifier 130. Remote server 110 can supplement, support, or replace some or all of the functionality of cloud computing system 50, cell tower network 102, antenna system 104, and cognitive analyzer/classifier 130.

In operation, the smart refrigerator 120 uses the sensor system 122 to gather sensed data about items stored within the smart refrigerator 120. In embodiments of the invention, the sensor system 122 includes a variety of sensor types. In embodiments of the invention, the sensor types in the sensor system 122 include the smart shelves 124 and one or more cameras 126. The sensed data gathered by the smart shelves 124 includes size data that represents the size of stored items, along with weight data that represents the weight of stored items. The sensed data gathered by the cameras 126 includes image data that represents images of the stored items. In embodiments of the invention, a light or infrared camera (not shown) can be provided and activated when the camera 126 captures image data.

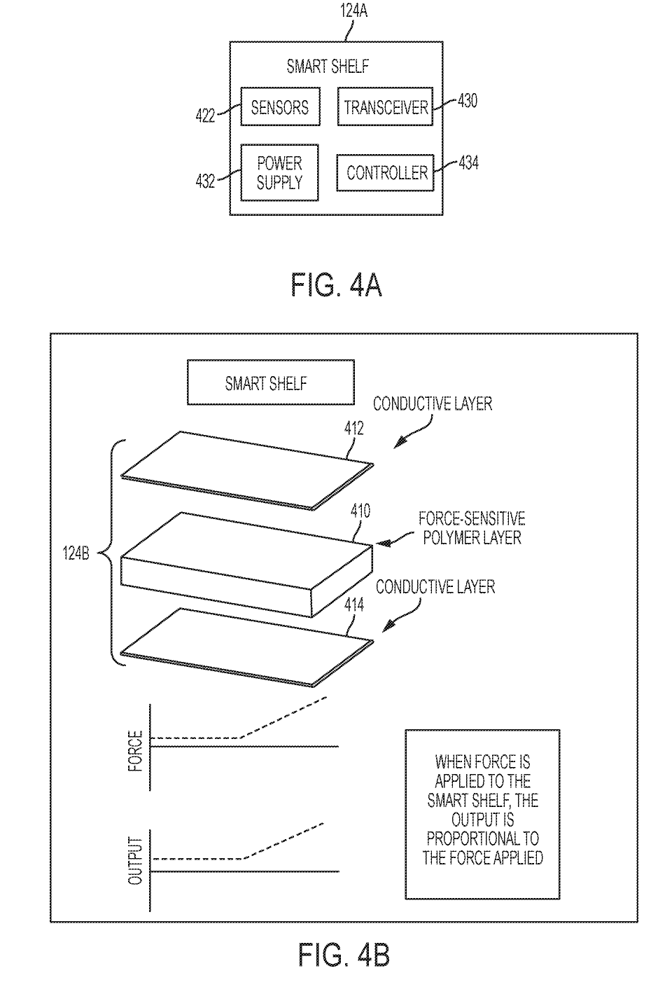

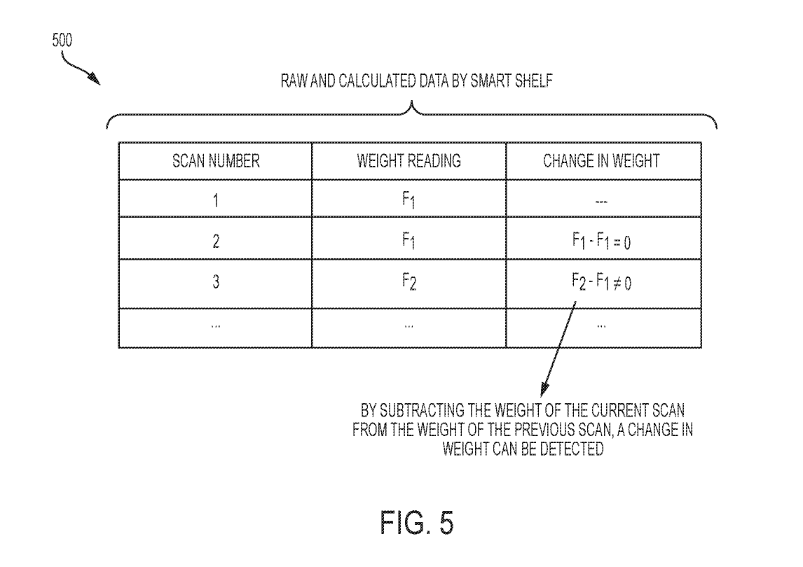

According to embodiments of the invention, the smart shelves 124 are configured and arranged to include sensors 422 (shown in FIG. 4A) that provide electrical outputs based on interaction between a surface area of the stored item and the smart shelves 124 when the stored item is placed thereon. In embodiments of the invention, the sensors 422 can be implemented as piezoresistive and/or piezoelectric transducers that generate a resistive or electrical output based at least in part on a mechanical input (pressure, force, or acceleration for example). In embodiments of the invention, the smart shelves 124 are further configured to include conductive layers 412, 414 (shown in FIG. 4B) communicatively coupled to the sensors 422 such that, when any surface area of the stored item applies force to the shelves 124, an output signal (resistive and/or electrical) is generated having a magnitude that is proportional to the force applied to the shelf 124 by the surface area of the stored item. According to embodiments of the invention, the resistive and/or electrical output signal is processed to generate an estimate of the size/shape/contour/volume of the stored item. According to embodiments of the invention, the resistive and/or electrical output signal is processed to generate an estimate of the size/shape/contour/volume of the stored item, along with an estimate of the weight of the stored item. Additional details of the smart shelf 124 are described subsequently herein and are illustrated in FIGS. 4A, 4B, and 5.

The cognitive analyzer/classifier 130 receives sensed data from the sensing system 122. Although a variety of sensed data can be gathered by the sensing system 122 and provided to the cognitive analyzer/classifier 130, in embodiments of the invention, the sensed data include at least one of the size data that represents the size of stored items, the weight data that represents the weight of stored items, and the image data that represents images of the stored items. In embodiments of the invention, the sensed data used by the cognitive analyzer/classifier 130 includes a selection of one or more from the group consisting of the size data that represents the size of stored items, the weight data that represents the weight of stored items, and the image data that represents images of the stored items.

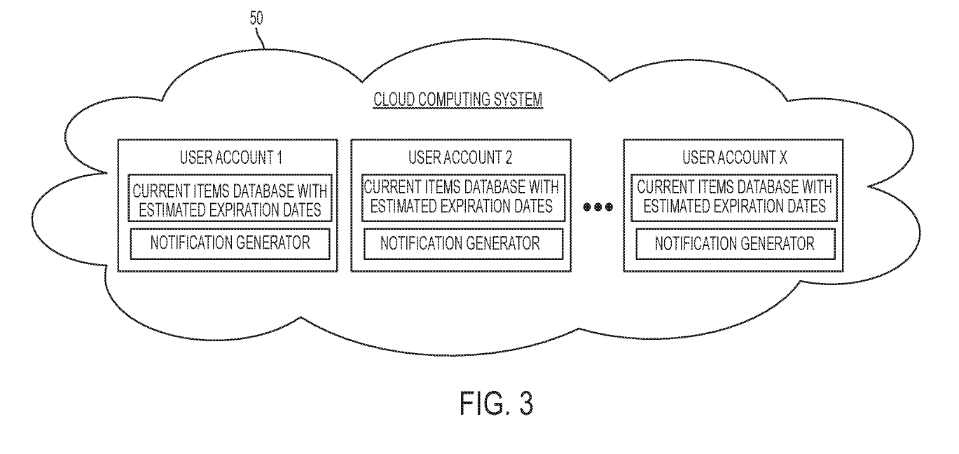

In accordance with embodiments of the invention, the cognitive analyzer/classifier 130 includes sufficient processing power to apply machine learning techniques to generate classification outputs related to stored items in the smart refrigerator 120. Two examples of the classification outputs are an identification of the stored item (e.g., by item identifier 140) and an estimate of the expiration date of the item (e.g., by expiration date estimator 142). The size data that represents the size of stored items, along with the weight data that represents the weight of stored items, are initially stored in the item size/weight engine 132. From the item size/weight engine 132, the size/weight data that represents the size/weight of stored items are stored in the item size database 134 and both the size/weight data from the item size/weight engine 132 and the size/weight data from the item size database 134 are provided to the item identifier 140. The item size database 134 includes historical item size data from prior sensor readings taken by sensor system 122. The item size database 134 can also include sensor readings from the sensor systems (not shown) of other users (e.g., User Account 1, User Account 2, etc. shown in FIG. 3), which can be stored at cloud computing system 50 (shown in FIG. 3) and accessed through the antenna 104 and cell tower network 102. The item size database 134 includes historical data about, for example, weights of full stored items, weights of empty containers/packages, typical shelf lives, sizes of packages/containers, etc.

Similarly, the image data that represents images of the stored items are provided to the visual recognition engine 136 which processes and interprets the image data. In embodiments of the invention, the visual recognition engine 136 can be provided with machine learning functionality to allow the visual recognition engine 136 to tag, classify, and search visual content in order to identify objects, colors, food, and other subjects that can provide insights about the object(s) depicted in the image data. From the visual recognition engine 136, the processed image data is stored in the item visual database 138, and both the processed image data from the visual recognition engine 136 and the stored processed image data from the item visual database 138 are provided to the item identifier 140. The item visual database 138 includes historical item image data from prior sensor readings taken by the sensor system 122. The item visual database 138 can also include sensor readings from the sensor systems (not shown) of other users (e.g., User Account 1, User Account 2, etc. shown in FIG. 3), which can be accessed through the antenna 104, cell tower network 102, and/or remote server 110. The item visual database 138 includes historical data about, for example, images of full stored items, images of empty containers/packages, images of packages/containers, etc.

In accordance with embodiments of the invention, the item identifier 140 includes sufficient processing power to receive, as training data, the above-described outputs from the item size/weight engine 132, the item size database 134, the visual recognition engine 136, and the item visual database 138. Machine learning techniques are applied to the training data to create/train/update stored item identification models. The item identifier 140 applies the stored item identification models to new sensed data (e.g., from the item size/weight engine 132 and the visual recognition engine 136) to generate stored item classification outputs that identify the stored item that generated the new sensed data. The item identifier 140 uses the new sensed data (e.g., from the item size/weight engine 132 and the visual recognition engine 136) and the classification outputs to update the stored item identification model to update the contents of the item size database 134 and the item visual database 138.

Similarly, in accordance with embodiments of the invention, the expiration date estimator 142 includes sufficient processing power to receive as training data (via the item identifier 140) the above-described outputs from the item size/weight engine 132, the item size database 134, the visual recognition engine 136, the item visual database 138, and item identifier 140. Machine learning techniques are applied to the training data to create/train/update stored item expiration date models. The expiration date estimator 142 applies the stored item expiration date models to new sensed data (e.g., from the item size/weight engine 132 and the visual recognition engine 136) to generate stored item classification outputs that estimate an expiration date for the stored item that generated the new sensed data. The expiration date estimator 142 uses the new sensed data (e.g., from the item size/weight engine 132 and the visual recognition engine 136) and the classification outputs to update the stored item expiration date model and to update the contents of the item size database 134 and the item visual database 138.

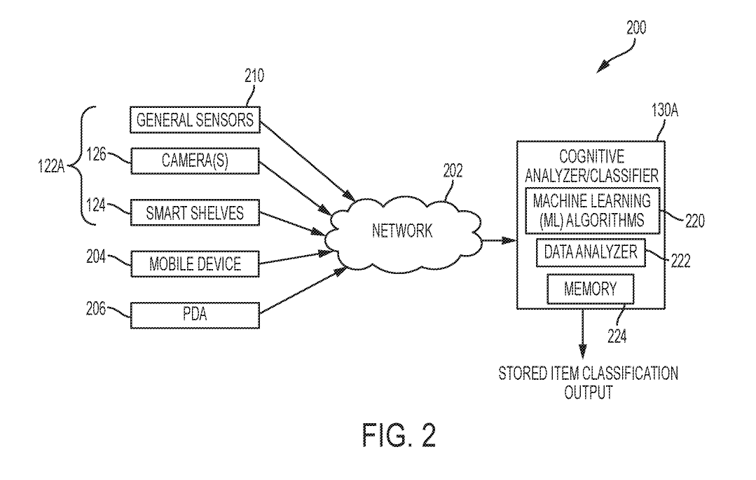

FIG. 2 depicts a block diagram of a portion of a system 200 embodying aspects of the invention. In system 100 (shown in FIG. 1), the relevant storage area is the refrigerator 120, and the cognitive analyzer/classifier 130 is more specifically tailored to identifying and estimating expiration dates of items stored in the refrigerator 120. In the system 200, the relevant storage area is more general and includes, for example, refrigerators, closets, pantries, drawers, suitcases, and the like. Also in the system 200, a cognitive analyzer/classifier 130A is provided as a more general implementation of the cognitive analyzer/classifier 130 (shown in FIG. 1). Like the system 100, the system 200 can be communicatively coupled through the antenna 104 (shown in FIG. 1) and the cell tower network 102 (shown in FIG. 1) to the cloud computing system 50 (shown in FIG. 1) and/or the remote server 110 (shown in FIG. 1). As with system 100, the cloud computing system 50 is in wired or wireless electronic communication with one or all of the components/modules of the system 200. Cloud computing system 50 can supplement, support, or replace some or all of the functionality of the components/modules of the system 200. Additionally, some or all of the functionality of the components/modules of the system 200 can be implemented as a node 10 (shown in FIG. 7) of cloud computing system 50.

The various components/modules of the system 200 are depicted separately for ease of illustration and explanation. In embodiments of the invention, the functions performed by the various components/modules of the system 200 can be distributed differently than shown. For example, some or all of the functionality of the cognitive analyzer/classifier 130A could be integrated in the mobile device 204 and/or the PDA 206.

As shown in FIG. 2, the system 200 includes a sensor system 122A, a mobile device 204, a personal digital assistant (PDA) 206, and a cognitive analyzer/classifier 130A communicatively coupled to one another through a communications network 202. The sensor system 122A includes general sensors 210, the cameras 126, and the smart shelves 124. The cognitive analyzer/classifier 130A includes machine learning algorithms 220, a data analyzer 222, and a memory 224. In accordance with embodiments of the invention, the cognitive analyzer/classifier 130A is configured and arranged to generate and output stored item classification outputs.

Stored items (not shown) can be positioned on the smart shelves 124. The sensor system 122A, in accordance with embodiments of the invention, gathers sensed data from general sensors 210, cameras 126, and smart shelves 124. More specifically, the sensor system 122A will gather general sensed data from the general sensors 210. The sensor system 122A also gathers, from the smart shelves 124, weight/size data that represents the weight/size of stored items positioned on the smart shelves 124. The sensor system 122A also gathers from the cameras 126 image data that represents an image of stored items positioned on the smart shelves 124. The general sensors 210 are chosen to provide any category of sensed data that can be used to determine any desired characteristics of the stored items.

The sensed data from the sensor system 122A is used as training data input to the ML algorithms 220. The ML algorithms 220 can include functionality that is necessary to interpret and utilize the outputs of the sensor system 122A. For example, the ML algorithms 220 can be provided with visual recognition software to interpret image data captured by the cameras 126 or the ML algorithms 220 can be provided with sufficient software to convert the electronic signals output from the sensors 210, 422 (shown in FIG. 4A) of the smart shelves 124 into weight/size data that represents an estimate of the weight/size of stored items positioned on the smart shelves 124.

The ML algorithms 220 are configured and arranged to apply machine learning techniques to the training data in order to, over time, create/train/update models of the stored items positioned on the smart shelves 124. The stored item model(s), when sufficiently trained, can be used to classify new sensed data into selected classification categories that provide desired information about the state of the stored item. In some embodiments of the invention, the ML algorithm 220 can be provided with an initial set of training data (e.g., images of known storage items) for supervised learning. In some embodiments of the invention, no initial storage item training data is provided, and the ML algorithm 220 proceeds under an unsupervised learning regiment. The ML algorithm 220 uses the stored item model and new sensed data to generate stored item classification outputs. Because new sensed data into the ML algorithm 220 further trains/updates the relevant stored item model, the ML algorithm 220 can automatically incorporate into the relevant stored item model new patterns exhibited by stored items.

In embodiments of the invention, the data analyzer 222 is configured to perform a prediction operation on the stored item classification output. In embodiments of the invention, the prediction operation includes constructing predictive features in order to predict features of the stored items, including, for example, that the stored item is a 20 ounce jar of grape jelly that is ½ full and has an estimated remaining freshness term of 3 months. The stored item classification output can be provided to the mobile device 204 and/or the PDA 206 for viewing at any time by the user and may also present a notification (e.g., noise, email, text, etc.) to a user when the item is nearing the end of its freshness term.

In embodiments of the invention, the system 200 is configured to be integrated as a retrofit component to an existing storage area. In embodiments of the invention, the features of the system 200 (specifically, cognitive analyzer/classifier 130A) can be integrated into the mobile device 204 and/or the PDA 206. In embodiments of the invention, additional computing power can be provided by implementing some of the functionality of system 200 (specifically, cognitive analyzer/classifier 130A) at the remote server 110 (shown in FIG. 1) or cloud computing system 50. In embodiments of the invention, a centralized computing facility employing IBM Watson technologies at remote server 110 or cloud computing system 50 can be utilized to make better predictions and train a larger body of sensed stored item data. In embodiments of the invention, the ML algorithms 220 draws on sensor readings from the sensor systems (not shown) of other users (e.g., User Account 1, User Account 2, etc. shown in FIG. 3), which can be stored at cloud computing system 50 (shown in FIG. 3) and accessed through the antenna 104 and cell tower network 102.

FIG. 3 depicts a block diagram showing additional details of the cloud computing system 50 embodying aspects of the invention. The systems 100, 200 can be configured to allow users to link their system 100, 200 to a personal user account (e.g., User Account 1, User Account 2, etc.) on a cloud/backend server (cloud computing system 50, remote server 110, etc.). The systems 100, 200 can store information, data, and pictures on the cloud computing system 50. The systems 100, 200 can connect users to their user account on the cloud using their mobile device, integrated refrigerator notification system (e.g. external display), or virtual assistant to receive notifications. The systems 100, 200 can be configured to store multiple user accounts on a cloud/backend server (cloud computing system 50, remote server 110, etc.), which can be accessed for a source of additional training data to improve system learning.

FIG. 4A depicts a block diagram illustrating a smart shelf 124A embodying aspects of the invention. The smart shelf 124A is an example implementation of the smart shelves 124 shown in FIGS. 1 and 2. The smart shelf 124A includes sensors 422, a transceiver 430, a controller 434, and a power supply 432, configured and arranged as shown. In embodiments of the invention, the sensors 422 can be implemented as piezoelectric and/or piezoresistive transducers. In embodiments of the invention, the power supply 432 can be replaced with a power source from another communicatively coupled system (e.g., the refrigerator 120 shown in FIG. 1). The sensors 422 are configured to function as transducers that generate a resistive and/or electrical output based at least in part on a mechanical input (pressure, force, or acceleration for example) from a surface of a storage item. In embodiments of the invention, the controller 434 is configured and arranged to interpret the output of the sensors 422 and, if necessary, convert the output from the sensors 422 to sensed data that can be read and processed by downstream components such as the cognitive analyzer classifier 130 (shown in FIG. 1) and/or the cognitive analyzer/classifier 130A (shown in FIG. 2). In embodiments of the invention, the controller 434 is configured to convert the outputs of the sensor 422 to weight data that represents the weight of a storage item on the shelf 124A. In embodiments of the invention, the controller 434 is configured to convert the outputs of the sensor 422 to size data that represents a size of the stored item, and more particularly that represents the area of a surface of a storage item that is exerting a force on the shelf 124A.

In embodiments of the invention, the controller 434 can process the outputs of the sensors 422 in order to identify the weight and/or size data belonging to a particular stored item in a variety of circumstances, including, for example, when the particular stored item is on the shelf 124A and in close proximity with other stored items, when the stored item is removed from one location on the shelf 124A and returned to another location on the shelf 124A, and when the stored item is removed from a location on one of the shelves 124A and returned to another location on another one of the shelves 124A. In embodiments of the invention, the controller 434 can be configured to include sufficient processing power to implement machine learning techniques to process the outputs of the sensors 422 in order to identify the weight and/or size data in the above-described manner. In embodiments of the invention, the controller 434 can be configured to include sufficient processing power to generate raw data from the sensors 422, and the machine learning techniques to process the raw data outputs of the sensors 422 in order to identify the weight and/or size data in the above-described manner can be provided by communicatively coupled downstream components such as the cognitive analyzer/classifier 130 (shown in FIG. 1) and the cognitive analyzer/classifier 130A (shown in FIG. 2). In embodiments of the invention, the transceiver 430 transmits (by wired or wireless coupling) the outputs of the sensors 422 and/or the controller 434 to upstream and/or downstream components (e.g., the cognitive analyzer/classifier 130 shown in FIG. 1 and/or the cognitive analyzer/classifier 130A shown in FIG. 2).

FIG. 4B depicts a block diagram illustrating a more detailed example of a smart shelf 124B embodying aspects of the invention. The smart shelf 124B is an example implementation of the smart shelves 124, 124A shown in FIGS. 1, 2, and 4A. The smart shelf 124B includes a force sensitive polymer layer 410, a top conductive layer 412, and a bottom conductive layer 414, configured and arranged as shown. As depicted by the two graphs shown in FIG. 4B, when force is applied to the smart shelf 124B, the output (e.g., electrical) is proportional to the force applied. The smart shelf 124B can, in the same manner as the smart shelf 124A, couple to and interact with the transceiver 430, the controller 434, and the power supply 432 shown in FIG. 4A.

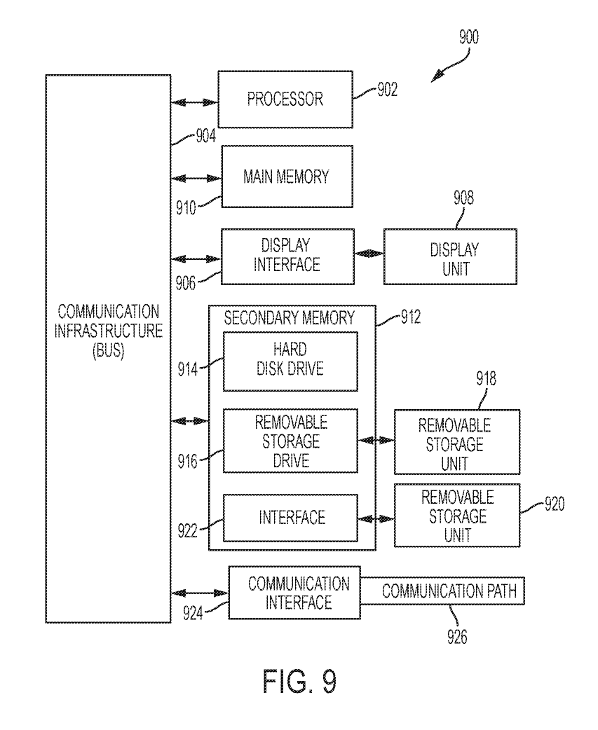

FIG. 5 depicts a table 500 illustrating examples of raw and calculated weight data that can be gathered from the smart shelves 124, 124A, 124B (shown in FIGS. 1, 2, 4A, 4B) and stored (e.g., in memory of controller 434 shown in FIG. 4A, cloud server 50, remote server 110, the memory 224 shown in FIG. 2, main memory 910 shown in FIG. 9, secondary memory 912 shown in FIG. 9, etc.) according to embodiments of the invention. The table 500 shows weight reading from three (3) scans; namely, the weight readings F₁ and F₂; and a determination of the change in weight from the previous scan. In the first scan, a weight of F₁ is read. In the second scan the same F₁ weight is read, and the change in weight from the previous scan is zero (0). In the third scan, a different weight reading F₂ is read, and the change is weight from the preceding scan is non-zero. Scans may be taken periodically (e.g., once every 10 minutes) or may be initiated by the closing of a door.

In embodiments of the invention, the table 500 depicted in FIG. 5 can be implemented as a relational database that is located in memory (e.g., in a memory of controller 434 shown in FIG. 4A, cloud server 50, remote server 110 the memory 224 shown in FIG. 2, main memory 910 shown in FIG. 9, secondary memory 912 shown in FIG. 9, etc.) or any other storage location of system 100. In general, a database is a means of storing information in such a way that information can be retrieved from it. A relational database presents information in tables with rows and columns. A table is referred to as a relation in the sense that it is a collection of objects of the same type (rows). Data in a table can be related according to common keys or concepts, and the ability to retrieve related data from a table is the basis for the term relational database. A database management system (DBMS) handles the way data is stored, maintained, and retrieved. In the case of a relational database, a relational database management system (RDBMS) performs these tasks.

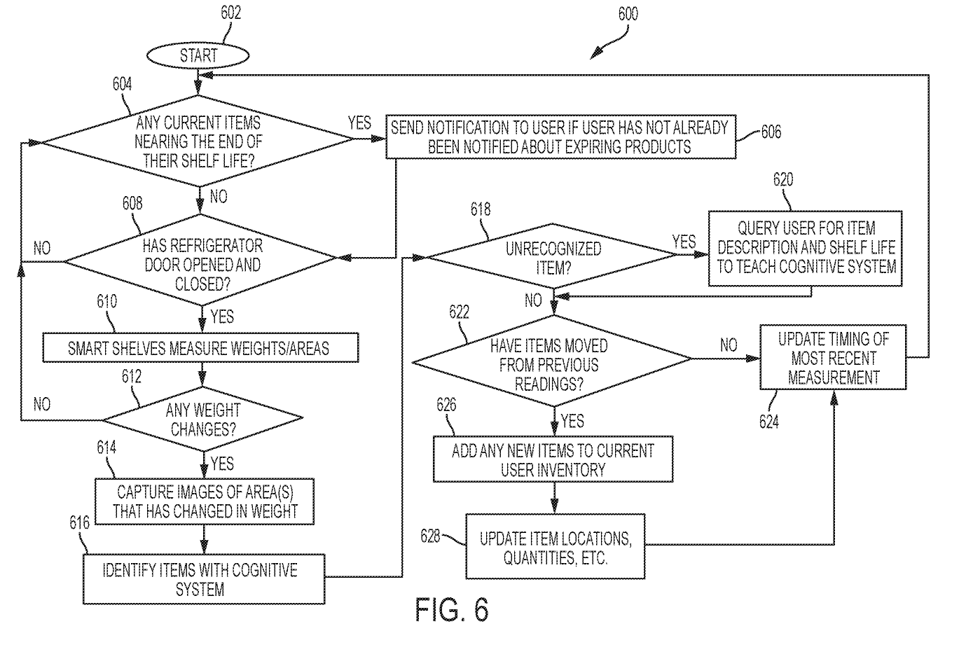

FIG. 6 depicts a flow diagram illustrating a methodology 600 according to embodiments of the present invention. Although the methodology 600 depicted in FIG. 6 is described in the context of applying embodiments of the invention to the system 100, the methodology 600 can be performed using the more general system 200 shown in FIG. 2. The methodology 600 begins at block 602 and moves to decision block 604 to determine whether any current stored items are nearing the end of their shelf life. If the answer to the inquiry at decision block 604 is yes, the methodology 600 moves to block 606 and sends a notification to the user for all identified items (e.g., using notification device 128 shown in FIG. 1). Once a notification is sent for a particular item, a flag may be set such that the user is not notified again about the same item for a threshold amount of time (e.g., 1 day). After a notification is sent or if the answer to the inquiry at decision block 604 is no, the methodology 600 moves to decision block 608 to determine whether a door of the refrigerator 120 has opened and closed. If the answer to the inquiry at decision block 608 is no, the methodology 600 returns to decision block 604. If the answer to the inquiry at decision block 608 is yes, the methodology 600 moves to block 610 and initiates a data scan at the smart shelves 124. From block 610, the methodology 600 moves to decision block 612 to determine whether any weights have changed from one data scan to another. If the answer to the inquiry at decision block 612 is no, the methodology 600 returns to decision block 604. If the answer to the inquiry at decision block 612 is yes, the methodology 600 moves to block 614 and initiates the cameras 126 capturing image data that represents an image of area(s) that have changed in weight.

In block 616, the system 100 (or 200), and particularly the cognitive analyzer/classifier 130 (or 130A), is used to determine the identity and/or other characteristics of the stored item. The methodology 600 then proceeds to decision block 618 to determine whether any stored item is unrecognized. If the answer to the inquiry at decision block 618 is yes, the methodology 600 proceeds to block 620 to, optionally, query user 1 for a description of the stored item and or the stored item's shelf life in order to teach (provide additional and more reliable training data to) the cognitive system. From block 620, the methodology 600 moves to decision block 622.

Returning to block 618, if the answer to the inquiry at decision block 618 is no, the methodology 600 proceeds to decision block 622 to determine whether stored items have moved from previous readings. If the answer to the inquiry at decision block 622 is no, block 624 updates the timing of the most recent measurement/scan. The timing measurements are useful for determining the duration that the item spent outside the refrigerator such that freshness terms can be accurately estimated. From block 624, the methodology 600 returns to decision block 604. If the answer to the inquiry at decision block 622 is yes, the methodology 600 moves to block 626 and adds any new stored items to the current user inventory. In block 628, item locations, quantities, etc. of stored items are updated. From block 628, the methodology moves to block 624.

The systems 100, 200 described and illustrated herein enable a wide range of cognitive functionality. The combination of the cognitive analyzer/classifier 130, the camera(s) 126, and the smart shelves 124 can detect which stored items are in the refrigerator 120, where they are, how often they are used/moved, etc. The refrigerator 120 can be linked to the cognitive analyzer/classifier 130 that identifies stored items and automatically adds the identified stored item to a personal inventory list with an estimated expiration date. Users can be notified of impending expiring stored items so that they can use the stored item before it spoils. Identification of stored items that are potentially spoiled because they have passed their expiration date can potentially assist in avoiding sickness. When a user places a stored item on a smart shelf 124A, 124B, the shelf measures and stores the relative data of the stored item (i.e., item weight, surface area, an estimate of size/shape/volume, location, etc.).

Weight change on a shelf and/or closing of the refrigerator door can also activate a camera(s). The camera image(s) combined with the shape of the surface touching the smart shelf can be used in conjunction with cognitive analytics to identify stored items. Visual recognition software can be used in the area of the image that a change in weight was detected. If some or all of the stored item is obscured from view of the camera, the bottom surface area can be used in conjunction with what can be seen to identify a stored item. If one stored item is placed on top of another, the change in weight in that area detected by the smart shelf combined with camera images can still be used to help identify the stored item.

A database can be provided on the cognitive server that contains images of stored items to compare to, weights of full stored items, weights of empty containers/packages, typical shelf lives, sizes of packages/containers, etc. Once identified, the stored item can be added to a user's personal database (of items in their refrigerator), along with the quantity remaining (measured with weight sensors in the shelves), and the time the stored item was last moved. Additionally upon identification, the cognitive system (e.g., 100 or 200) can be used to assign an estimated expiration date. Initial shelf lives for stored items can be programmed on the system's backend server (e.g., cloud computing system 50, remote server 110, etc.). Stored item shelf lives can be entered by users if the stored item is not found by the systems 100, 200 to teach the cognitive server for all users of the cognitive system. The systems 100, 200 can be configured to activate stored item measurement/identification only when the refrigerator door closes to save on processing power.

The systems 100, 200 can learn and update stored item shelf lives based on user interaction with the stored items. If a user discards a stored item after the estimated expiration date is reached, the systems 100, 200 will make the assumption that it is doing a good job at setting a shelf life for that stored item. If multiple users (across a plurality of refrigerators using the disclosed systems 100, 200 as shown in FIG. 3) continue use of the stored item after the estimated expiration date, the systems 100, 200 will learn that it needs to extend the shelf life setting for that stored item in the future. If a user discards a stored item that had a substantial amount of the stored item remaining (and is more than they would typically use in a single sitting) such as half a bottle of ketchup, the systems 100, 200 will learn that it needs to shorten the shelf life setting for that stored item in the future. Users could also give feedback if a stored item spoils and they weren't notified such that the systems 100, 200 will receive additional training data for learning.

The systems 100, 200 can be configured to update (or scan) any time a stored item is moved. If a stored item is removed from the shelf and put back within a threshold time and is less than or equal to the previous weight of stored item, the systems 100, 200 can be configured to assume that the current stored item was used and put back on the shelf so the systems 100, 200 will not update the expiration date. Alternatively, the amount of time that the item spent outside the refrigerator may be used to update the expiration date (i.e., if an item was removed from the refrigerator for 5 minutes, there may be no change to the estimated expiration data, but if that same item was removed for 2 hours, the estimated expiration data may be shortened). The systems 100, 200 can also be configured to recognize if a stored item was moved to a different shelf in the same refrigerator.

If a user stores leftovers, the systems 100, 200 can be configured to learn the user's typical containers and assign a general shelf life for leftovers. The systems can be configured to assign a more accurate shelf life based on what the user made, which the systems 100, 200 can be configured to “figure out” based on the stored items removed from the shelves in the hours prior to the leftovers being put on the shelf. The systems 100, 200 can be configured to learn over time how long users typically keep their leftovers. The systems 100, 200 can be configured to alternatively learn through user input of the first few storage items. The systems 100, 200 can be configured to identify the leftovers through visual recognition (through the cameras 126) if a container holding the storage item is clear or is marked by the user (i.e., item description written on a bag, tag, sticker, etc.).

The systems 100, 200 can be configured to provide notifications to users under a variety of conditions, including, for example, prior to a stored item reaching its estimated expiration date, if a stored item is running low, if a stored item is not sealed properly, or if an item is stored in the wrong type of container.

The systems 100, 200 can link the notification system (e.g., notification device 128) to a user's personal mobile device, integrated refrigerator notification system (e.g. external display), virtual assistants, etc. The systems 100, 200 can be configured to provide immediate notification when a user moves an expired stored item in an effort to remind them one more time in case they were about to consume the stored item. The systems 100, 200 can be configured to monitor stored items so that low quantity warnings are sent with enough time for the user to replace the stored item before completely running out.

The systems 100, 200 can be configured to recognize when a user's refrigerator is filled more than usual which can suggest an upcoming party or that guests will be visiting. In such a situation, the systems 100, 200 can provide reminder notifications for stored items that the user may or may not have enough of that have been used at past parties even though they would not have been notified of yet if a “party” was not recognized. The systems 100, 200 can be configured to suggest recipes that would allow the user to make use of the stored items that are nearing the end of their shelf life.

The systems 100, 200 can be configured to allow users to link their system 100 to a personal user account on a cloud/backend server (cloud computing system 50, remote server 110, etc., as shown in FIG. 3). The systems 100, 200 can store information, data, and pictures on the cloud computing system 50. The systems 100, 200 can connect users to their user account on the cloud using their mobile device, integrated refrigerator notification system (e.g. external display), or virtual assistant to receive notifications. The systems 100, 200 can be configured to store multiple user accounts on a cloud/backend server (cloud computing system 50, remote server 110, etc., as shown in FIG. 3), which can be accessed for a source of additional training data to improve system learning.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

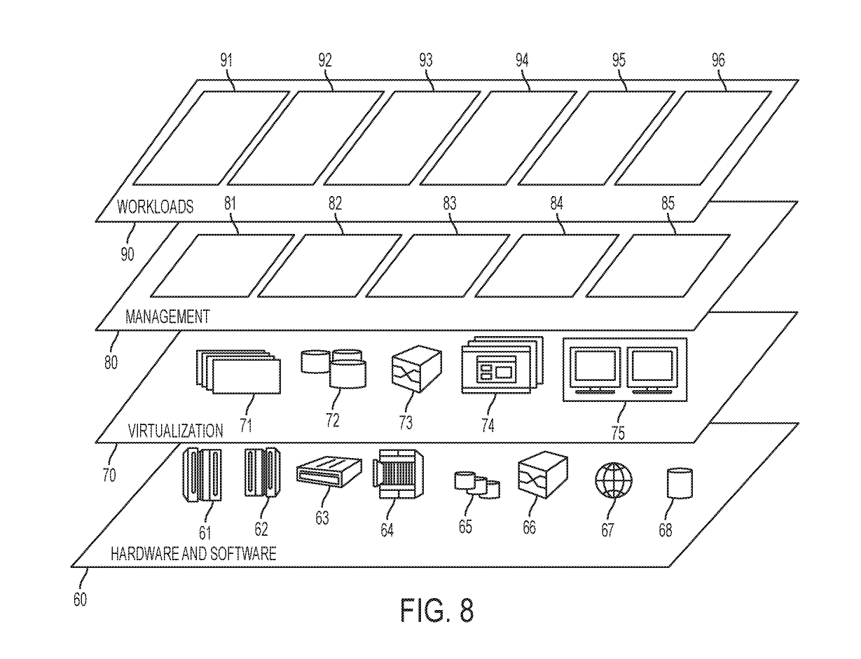

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the automated identification, status monitoring and notifications of stored items 96.

FIG. 9 depicts a high level block diagram computer system 900, which can be used to implement one or more aspects of the present invention. More specifically, computer system 900 can be used to implement some hardware components of embodiments of the present invention. Although one exemplary computer system 900 is shown, computer system 900 includes a communication path 926, which connects computer system 900 to additional systems (not depicted) and can include one or more wide area networks (WANs) and/or local area networks (LANs) such as the Internet, intranet(s), and/or wireless communication network(s). Computer system 900 and additional system are in communication via communication path 926, e.g., to communicate data between them.

Computer system 900 includes one or more processors, such as processor 902. Processor 902 is connected to a communication infrastructure 904 (e.g., a communications bus, cross-over bar, or network). Computer system 900 can include a display interface 906 that forwards graphics, text, and other data from communication infrastructure 904 (or from a frame buffer not shown) for display on a display unit 908. Computer system 900 also includes a main memory 910, preferably random access memory (RAM), and can also include a secondary memory 912. Secondary memory 912 can include, for example, a hard disk drive 914 and/or a removable storage drive 916, representing, for example, a floppy disk drive, a magnetic tape drive, or an optical disk drive. Removable storage drive 916 reads from and/or writes to a removable storage unit 918 in a manner well known to those having ordinary skill in the art. Removable storage unit 918 represents, for example, a floppy disk, a compact disc, a magnetic tape, or an optical disk, etc. which is read by and written to by removable storage drive 916. As will be appreciated, removable storage unit 918 includes a computer readable medium having stored therein computer software and/ or data.

In alternative embodiments, secondary memory 912 can include other similar means for allowing computer programs or other instructions to be loaded into the computer system. Such means can include, for example, a removable storage unit 920 and an interface 922. Examples of such means can include a program package and package interface (such as that found in video game devices), a removable memory chip (such as an EPROM, or PROM) and associated socket, and other removable storage units 920 and interfaces 922 which allow software and data to be transferred from the removable storage unit 920 to computer system 900.

Computer system 900 can also include a communications interface 924. Communications interface 924 allows software and data to be transferred between the computer system and external devices. Examples of communications interface 924 can include a modem, a network interface (such as an Ethernet card), a communications port, or a PCM-CIA slot and card, etcetera. Software and data transferred via communications interface 924 are in the form of signals which can be, for example, electronic, electromagnetic, optical, or other signals capable of being received by communications interface 924. These signals are provided to communications interface 924 via communication path (i.e., channel) 926. Communication path 926 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 910 and secondary memory 912, removable storage drive 916, and a hard disk installed in hard disk drive 914. Computer programs (also called computer control logic) are stored in main memory 910 and/or secondary memory 912. Computer programs can also be received via communications interface 924. Such computer programs, when run, enable the computer system to perform the features of the present invention as discussed herein. In particular, the computer programs, when run, enable processor 902 to perform the features of the computer system. Accordingly, such computer programs represent controllers of the computer system.

Many of the functional units described in this specification have been labeled as modules. Embodiments of the present invention apply to a wide variety of module implementations. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, comprise the module and achieve the stated purpose for the module.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method for monitoring items in a storage area, the method comprising:
generating, using a sensor system, sensed weight data that represents weights of a plurality of stored items;
generating, using the sensor system, sensed surface area data that represents surface areas of the plurality of stored items;
based at least in part on the sensed weight data and the sensed surface area data, using a classifier to create, train, and update a stored item model; and
based at least in part on new sensed weight data and new sensed surface area data, generating, using the classifier and the stored item model, a stored item classification output.

2. The computer-implemented method of claim 1 further comprising receiving, using the sensor system, sensed image data that represents at least one image of each of the plurality of stored items.

3. The computer-implemented method of claim 2 further comprising, based at least in part on the sensed image data, using the classifier to create, train, and update the stored item model.

4. The computer-implemented method of claim 3 further comprising, based at least in part on new sensed image data, generating, using the classifier and the stored item model, the stored item classification output.

5. The computer-implemented method of claim 4 further comprising:
based at least in part on the classification output, generating and transmitting a notification about at least one of the plurality of stored items;
wherein the stored item classification output comprises an estimation of an expiration date for each of the plurality of stored items;
wherein the classifier is configured to learn aspects of the estimation of the expiration date and update the estimation of the expiration date.

6. The computer-implemented method of claim 1 wherein the sensor system comprises a force sensitive sensor.

7. The computer-implemented method of claim 6 further comprising, based at least in part on surface areas of the plurality of stored items causing changes in a force detected by the force sensitive sensor, generating the surface area data.

8. A computer system for monitoring items in a storage area, the computer system comprising:
a processor circuit communicatively coupled to a memory, wherein the processor circuit is configured to perform a method comprising:
receiving, from a sensor system, sensed weight data that represents weights of a plurality of stored items;
receiving, from the sensor system, sensed surface area data that represents surface areas of the plurality of stored items;
based at least in part on the sensed weight data and the sensed surface area data, using a classifier to create, train, and update a stored item model; and
based at least in part on new sensed weight data and new sensed surface area data, generating, using the classifier and the stored item model, a stored item classification output.

9. The computer system of claim 8 further comprising receiving, from the sensor system, sensed image data that represents at least one image of each of the plurality of stored items.

10. The computer system of claim 8 further comprising, based at least in part on the sensed image data, using the classifier to create, train, and update the stored item model.

11. The computer system of claim 10 further comprising, based at least in part on new sensed image data, generating, using the classifier and the stored item model, the stored item classification output.

12. The computer system of claim 11 further comprising:
based at least in part on the classification output, generating and transmitting a notification about at least one of the plurality of stored items;
wherein the stored item classification output comprises an estimation of an expiration date for each of the plurality of stored items;
wherein the classifier is configured to learn aspects of the estimation of the expiration date and update the estimation of the expiration date.

13. The computer system of claim 8 wherein the sensor system comprises a force sensitive sensor.

14. The computer system of claim 13 further comprising, based at least in part on surface areas of the plurality of stored items causing changes in a force detected by the force sensitive sensor, generating the surface area data.

15. A computer program product for monitoring items in a storage area, the computer program product comprising:
a computer readable storage medium having program instructions embodied therewith, wherein the program instructions are readable by a processor circuit, wherein the program instructions are readable by the processor circuit to cause the processor circuit to perform a method comprising:
receiving, from a sensor system, sensed weight data that represents weights of a plurality of stored items;
receiving, from the sensor system, sensed surface area data that represents surface areas of the plurality of stored items;
based at least in part on the sensed weight data and the sensed surface area data, using a classifier of the processor circuit to create, train, and update a stored item model; and
based at least in part on new sensed weight data and new sensed surface area data, generating, using the classifier and the stored item model, a stored item classification output.

16. The computer program product of claim 15 further comprising receiving, from the sensor system, sensed image data that represents at least one image of each of the plurality of stored items.

17. The computer program product of claim 15 further comprising, based at least in part on the sensed image data, using the classifier to create, train, and update the stored item model.

18. The computer program product of claim 17 further comprising, based at least in part on new sensed image data, generating, using the classifier and the stored item model, the stored item classification output.

19. The computer program product of claim 18 further comprising:
based at least in part on the classification output, generating and transmitting a notification about at least one of the plurality of stored items;
wherein the stored item classification output comprises an estimation of an expiration date for each of the plurality of stored items;
wherein the classifier is configured to learn aspects of the estimation of the expiration date and update the estimation of the expiration date.

20. The computer program product of claim 15, wherein:
the sensor system comprises a force sensitive sensor; and
the method performed by the processor circuit further comprises:
based at least in part on surface areas of the plurality of stored items causing changes in a force detected by the force sensitive sensor, generating the surface area data;
wherein the force sensitive sensor is configured to be integrated into a plurality of shelves;
wherein the plurality of shelves is configured to support the plurality of stored items.
